(19) United States
(12) Patent Application Publication
(10) Pub. No.: US 2002/0144952 A1
(43) Pub. Date: Oct. 10, 2002

(54) Self-cleaning filter

(76) Inventor: Terrence Lee Saxton, Ashby, MN (US)

Correspondence Address: Stuart R. Hemphill, Dorsey & Whitney LLP, Pillsbury Center South, 220 South Sixth Street, Minneapolis, MN, 55402-1498, US

(21) Appl. No.: 09/829,354

(22) Filed: Apr. 9, 2001

(51) Int. Cl. B01D 35/22

(52) U.S. Cl. 210/739; 210/97; 210/106; 210/136; 210/137; 210/741; 210/791

(57) ABSTRACT

The present invention is a self-cleaning water filter and method by which sediment is flushed from a water filter, wherein the device is a flush pipe connected to a filter housing, wherein the pipe is attached to a solenoid valve and controller mechanism, generally a timer, meter or sensor. The method of the present invention provides automatically cleaning a water filter comprising the steps of attaching a flush pipe to a filter housing and attaching a solenoid valve and controller mechanism to the pipe.

### FIELD OF THE INVENTION

This invention relates generally to water filters. More specifically, the device of the present invention relates to automated self-cleaning water filters.

### BACKGROUND

Water filters are used in many situations to collect and remove sediment from a water flow stream. Numerous problems can arise when sediment plugs up household appliances. Common problems include reduced water pressure, sediment build-up in faucets and water heaters, clogging of pipes and water softeners, heaters, and other appliances such as dishwashers. In addition, sediment build-up causes premature aging of some appliances, which can lead to expensive service calls or replacement. Thus, water filters are used to remove particulate matter before the water reaches common household appliances such as water softeners, water heaters and boilers.

Replaceable cartridge-style filters are most commonly used to remove sediment. Such filters need to be changed regularly, and the process can be difficult and time-consuming because, among other reasons, the filters are often hard to reach. In addition, changing a filter may require a trained serviceman who can be expensive and hard to contact and whose services may require a long wait. Accordingly, there is a need in the water filter business for an improved water filter.

### SUMMARY

The present invention satisfies the need for a reliable filter that does not have to be changed on a regular basis. Specifically, the device of the present invention is an automated self-cleaning water filter. More specifically, the device of the present invention is a water filter comprising a mechanism by which collected particulate matter is flushed from the filter.

Accordingly, one embodiment of the present invention provides an automated, self-cleaning water filter utilizing a timer and solenoid valve combination to flush sediment from a filter.

Another embodiment of the present invention provides an automated, self-cleaning filter that flushes sediment from the filter using a metering mechanism attached to a solenoid valve.

Another embodiment of the present invention provides an automated, self-cleaning filter that flushes sediment from the filter using a pressure sensing device coupled with inlet and outlet pressure sensors and attached to a solenoid valve.

Another embodiment of the present invention provides an automated, self-cleaning filter that flushes sediment from the filter using an optical sensor attached to a solenoid valve.

Another embodiment of the present invention provides a kit for converting a standard water filter into an automated, self cleaning filter.

Another embodiment of the present invention provides a method for automatically cleaning a water filter comprising the steps of attaching an outlet pipe to a filter housing and attaching a solenoid valve and controller to the pipe downstream from the filter.

These and other features, aspects, and advantages of the present invention will become better understood with regard to the following description, appended claims, and accompanying drawings.

### BRIEF DESCRIPTION OF THE DRAWINGS

FIG. 1 is an embodiment of the present invention;

FIG. 2 is another embodiment of the present invention,

FIG. 3 is another embodiment of the present invention,

FIG. 4 is another embodiment of the present invention with pre-existing parts shown in phantom lines, and

FIG. 5 is a schematic representation showing flow within the present invention.

### DETAILED DESCRIPTION

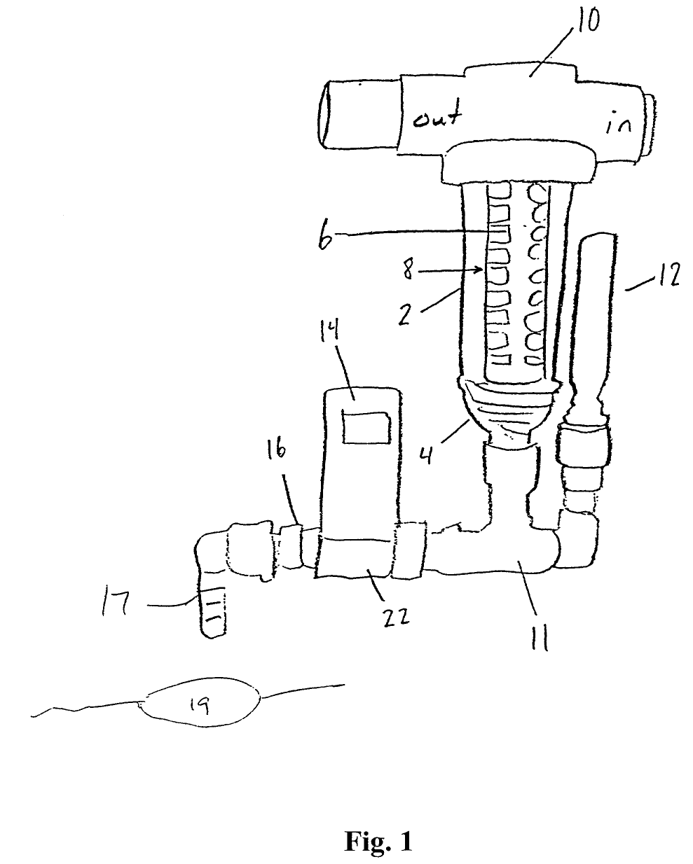

FIG. 1 shows one embodiment of the present invention. A water filter 8 is enclosed within a filter housing 2. The housing 2 has a filter bowl 4 at its lower end. Within the water filter 8 is a mesh screen 6 or other media that blocks particles over a specified size but allows water to pass through. Both the filter housing 2 and the filter 8 are attached to the filter head 10. The lower end of the filter bowl 4 as shown in FIG. 1 is threaded for connection to a flush pipe 11 in the form of a “T” joint, leading in one direction to a water hammer arrestor 12 and in the other direction to a flush valve, preferably a solenoid valve 22 and timer 14 combination. In other embodiments, the filter bowl 4 could be glue-joined to the flush pipe 11 using standard PVC glue and primer. A check valve 16, which is preferred but not necessary, is located downstream from the solenoid valve 22. A drain conduit 17 extends from the check valve 16 to any suitable drain 19.

The water filter 8 of the present invention is a standard filter such as a Rusco brand water filter. Other filters such as a Vu-Flow filter or any other filter capable of attachment to the flush pipe 11 can be used. As noted, the filter contains a mesh screen 6 or other filter media that blocks particles over a specified size but allows water to pass through. The screen 6 can be either plastic or nylon and varies in pore size depending on the application. The screen, and thus the pore size, is interchangeable within the filter. In other words, a new screen having a different pore size can be substituted if the current screen is not filtering to the desired extent.

The filter housing 2 and bowl 4 are generally made of various plastics and are well known in the industry. The filter head 10 is also standard and well known in the industry. In the embodiment shown in FIG. 1, both the filter 8 and filter housing 2 are connected to the filter head 10 via a threaded system and sealed by one or more o-rings (not shown).

The water hammer arrestor 12 shown in FIG. 1 is a Sioux Chief model 660-2. In other embodiments, alternative water hammer arrestors such as PVC units or the ACME brand arrestor are used. Use of a water hammer arrestor is preferred, but not necessary. If no water hammer arrestor is used, the flush pipe 11 may be an L-shaped pipe leading to the solenoid valve 22.

The timer 14 shown in FIG. 1 and serving as flush controller is a Burkert 1078-2 timer unit. A Burkert 1077-2 digital controller (not shown) is used by the technician to set the interval between flushes and the flush duration and then removed. That is, the technician operably connects the digital controller to the timer 14, sets the flush interval and duration values, and then removes the digital controller and places a plastic faceplate over the timer unit. Other timers such as a Nais LT4H, Nais PM4H-F, Omron H3CR or other similar timers can be used.

The timer 14 is connected to and controls operation of a solenoid valve 22. As shown in FIG. 1, the self-cleaning water filter of the present invention uses a ½ inch Burkert 6213 solenoid valve. The valve could also be a ⅜ inch Burkert 6213 or any other acceptable solenoid valve. The solenoid valve 22 and timer 14 can be wired for power at several acceptable voltages. Battery operation is also possible where wired power is unavailable.

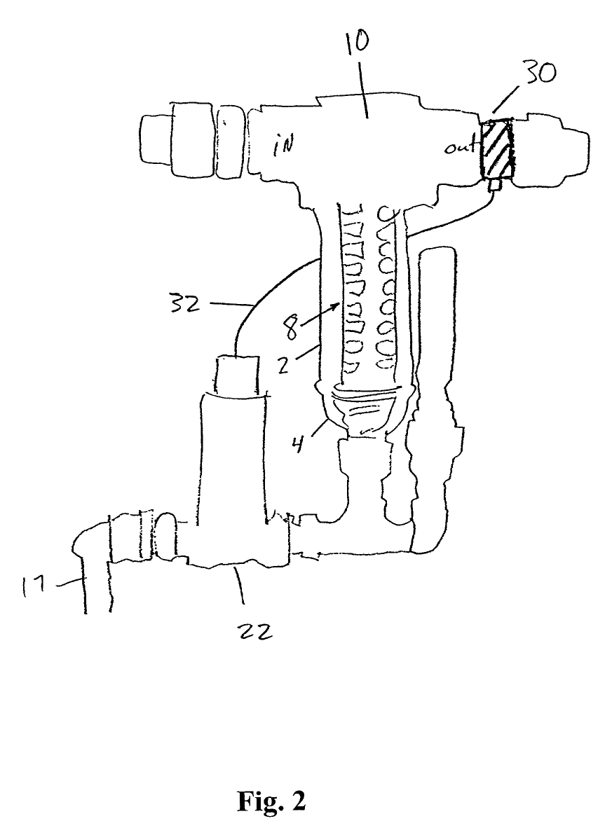

Another embodiment of the self-cleaning filter of the present invention is shown in FIG. 2. Like the first embodiment, the self-cleaning filter shown in FIG. 2 comprises a standard water filter 8, a filter housing 2 having a bowl 4, and a filter head 10. This embodiment, however, comprises a metering mechanism for a flush controller rather than a timer and solenoid valve combination. Specifically, this embodiment of the self-cleaning water filter provides an impeller style meter 30 connected to the solenoid valve 22 by a standard cable 32. A paddle wheel style meter or the like would also work. The meter 30 is located at the outlet portion of the filter head, and the meter 30 monitors the amount of water exiting the filter. In other embodiments, the meter 30 is located at the inlet portion of the filter head. The meter 30 is selectively programmed to provide a signal to open the solenoid valve 22 after a particular amount of water passes through. For instance, the meter 30 could trigger the solenoid valve 22 to open after 2000 gallons of water have been filtered. This selected value can be changed depending on the amount of particulate in the water, i.e., the system can be programmed to flush more often in areas where the water supply is high in sediment.

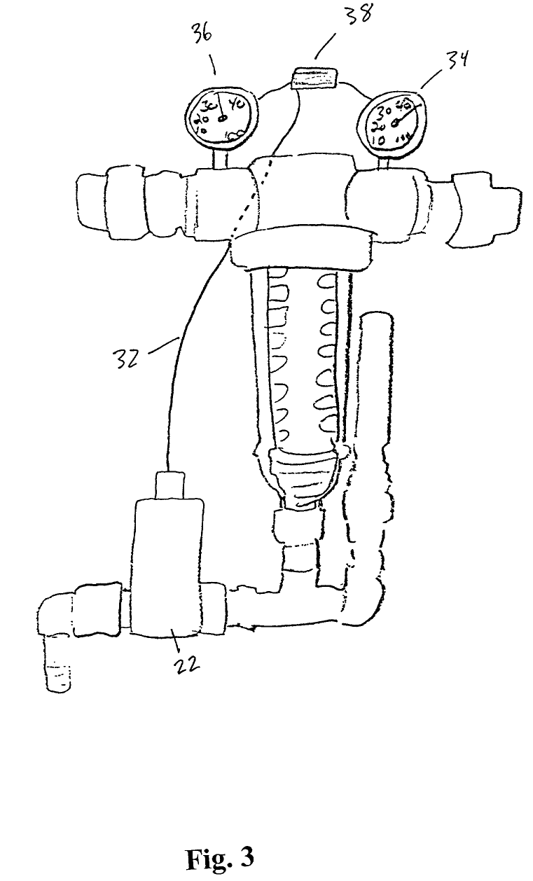

FIG. 3 shows an embodiment of the present invention having a pressure drop sensor flush controller, comprising two pressure sensors and interface logic controlling the solenoid valve. The embodiment of FIG. 3 comprises a first pressure sensor 34 located at the filter head inlet, a second pressure sensor 36 at the filter head outlet, and interface logic 38 connected to each of the two sensors. The first and second pressure sensors 34, 36 measure the water pressure as it comes into and exits the filter head, respectively. The interface logic 38 determines the difference in pressure values measured by the two sensors and compares that difference to a solenoid threshold valve. The interface logic 38 is connected to the solenoid valve 22 by a standard cable 32 and is programmed to open the solenoid valve 22 when the pressure difference values measured by the two sensors reaches a pre-determined level. The pressure difference (or drop) provides a measure of the degree to which accumulated sediment is blocking flow through the filter and needs to be flushed away.

Other flush control means would also work. For instance, an optical sensor could sense the amount of sediment in the filter bowl and trigger a flush when the sediment reaches a pre-determined level or degree of turbidity. Or, a sensor could be attached to the filter head outlet to measure flow efficiency as affected by accumulated sediment. The sensor would be programmed to actuate the solenoid valve when flow efficiency has sunk to unacceptable levels.

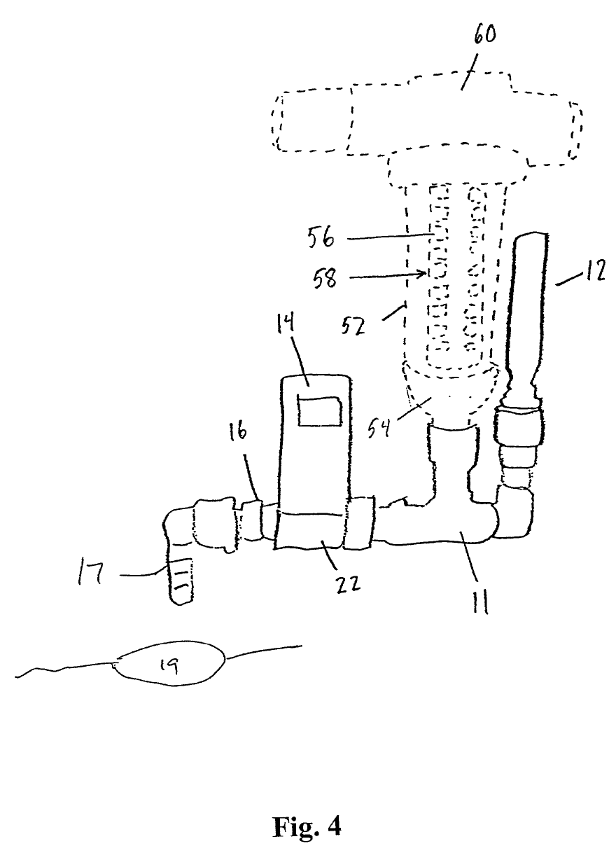

FIG. 4 shows an embodiment of the present invention in which only the lower, flushing portion of the device is provided. Some people already have in their homes or businesses water filters having filter bowls with attachment means. That is, some customers do not need all components of the present invention including the filter, filter housing and filter head. The embodiment of FIG. 4 is a kit that would convert a replaceable style filter into an automated, self-cleaning filter. This embodiment comprises a flush pipe 11, a solenoid valve 22 attached to a timer 14 or other flush control means of the present invention, a check valve 16 located downstream from the solenoid valve 22, and a drain conduit 17 leading to a drain 19. The filter head 60, filter 58, mesh screen 56, filter housing 52 and filter bowl 54 are shown in phantom. The flush pipe 11 is attached to the filter bowl 54 in the manner described previously. The embodiment shown in FIG. 4 could further provide a water hammer arrestor 12, but one is not necessary.

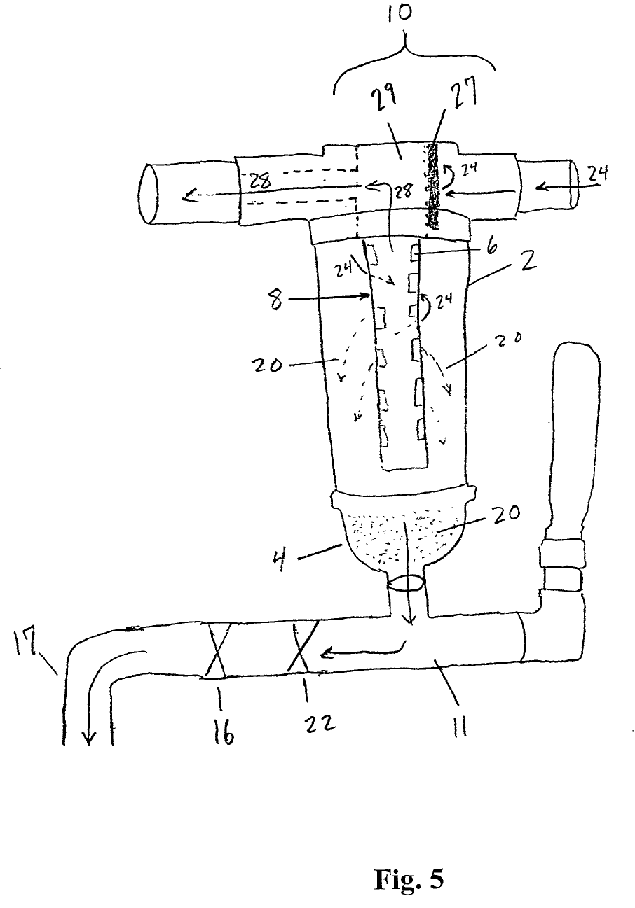

FIG. 5 shows the self cleaning filter of the present invention in operation. Unfiltered water 24 enters the filter housing 2 through the inlet of filter head 10. Once inside the housing 2, the water must exit through the interior of filter 8, i.e., the water must be filtered through the screen 6. The water 24 is thus filtered, and the clean water 28 resumes its flow and proceeds to a water softener, heater or boiler, etc. Sediment 20 filtered from the water and captured at the mesh screen 6 surface of the filter 8 falls into the bowl 4 where it accumulates.

With standard filters, particulate matter filtered out accumulates on the filter mesh 6 and below it until the filter is manually changed and flushed. With the self-cleaning filter of the present invention, however, sediment is removed periodically by automatic flushing of the filter. Flushing is actuated by a timer, meter or sensor, or other automated flush control depending on the embodiment. Regardless of the triggering means, the solenoid valve 22 is opened at predetermined intervals for a pre-determined duration, both of which are programmable. Opening of the solenoid valve 22 permits flow into the flush pipe 11. This causes more water 24 to enter the filter head 10, where it runs into a first fin 27, a second fin (not shown) and a circular fitting 29 connecting the filter head to the filter 8. The flow into flush pipe 11 and the water action in the filter head creates centrifugal flow, which causes a spiralling downward movement of the water. The spiralling water pulls particulate matter from the filter downward into the filter bowl 4, into the flush pipe 11, and out through the open solenoid valve 22 to a drain conduit 17. The check valve 16 is a one-way valve that prevents particulate-filled water from re-entering the filter area. The arrestor 12 prevents water hammer when the solenoid valve re-closes.

The interval of time during which the solenoid valve 22 remains open (flush cycle) is typically 3 to 5 seconds for a typical home system. This is sufficient to flush out most of the sediment in the bottom of the filter bowl 4. Too long a duration wastes water and causes an extended water pressure drop in the system fed by the invention. The solenoid valve 22 can be programmed to remain open for a single period of 5 seconds, for example, or it can open for two or more consecutive intervals of varying lengths. Regardless of the method, the solenoid valve 22 should remain open long enough to flush all or most particulates from the filter 8 and filter bowl 4.

The interval between actuations of the solenoid valve 22 can be determined by time or by amount of water passing through the unit or by other sensed variables that indicate sufficient sediment has accumulated that efficiency of filtering is affected. The timer 14 can be set to measure time between actuations and cause flushing at regular intervals. It could also cause flush actuation at a predetermined time or times each day. This could have the benefit of avoiding normal peak use times when the drop in water pressure might be noted. Alternatively, the signal to activate solenoid valve 22 can be provided by a flow sensor 30 that measures accumulated flow or by pressure difference/pressure drop sensing. Other values that could be sensed as indications of impaired filter efficiency are peak rate of flow which will drop as particulates clog the filter 8, or depth of accumulated sediment in the filter bowl 4.

Although the present invention has been described in detail with reference to certain preferred versions thereof, other versions are possible. Therefore, the spirit and scope of the appended claims should not be limited to the description of the preferred versions contained herein.

What is claimed is:

1. A self cleaning water filter comprising:
a filter head;
a water filter attached to said filter head, wherein said water filter removes particulate matter;
a filter housing unit surrounding said water filter and attached to said filter head, wherein said filter housing unit has a filter bowl at its base;
a flush pipe attached to said filter bowl, wherein said flush pipe extends away from said filter bowl and splits into a first end and a second end;
a water hammer arrestor attached to said first end of said flush pipe;
a solenoid valve attached to said second end of said flush pipe;
a controller operably connected to activate said solenoid valve for a flush cycle; and
a drain conduit located downstream from said solenoid valve.

2. The self-cleaning water filter of claim 1, further comprising a check valve located downstream from the solenoid valve.

3. The self-cleaning water filter of claim 2, wherein said water filter is a Rusco brand filter.

4. The self-cleaning water filter of claim 3, wherein said water hammer arrestor is a Sioux Chief model 660-2.

5. The self-cleaning filter of claim 4, wherein said solenoid valve is a Burkert 6213 valve.

6. The self-cleaning filter of claim 5, wherein said controller is a Burkert 1078-2 timer.

7. A kit for converting a standard water filter to an automated self-cleaning water filter, the kit comprising:
a flush pipe for attachment to a water filter housing;
a flush valve attached to said flush pipe to open said flush pipe for flushing; and
an automated flush controller operably attached to said flush valve.

8. The kit of claim 7, wherein the flush valve is a solenoid valve and further comprising a check valve located downstream from said solenoid valve.

9. The kit of claim 7, wherein said flush controller comprises an accumulated flow metering mechanism, wherein said metering mechanism is connected to sense flow through the water filter housing.

10. The kit of claim 9, wherein said metering mechanism is an impeller style meter.

11. The kit of claim 9, wherein said metering mechanism is a paddle wheel style meter.

12. The kit of claim 7, wherein the flush controller is a timer.

13. The kit of claim 7, wherein the flush controller comprises:
a first pressure sensor connected to a filter head inlet;
a second pressure sensor connected to a filter head outlet; and
interface logic for determining the difference between pressures measured by said first and said second pressure sensors.

14. The kit of claim 7, wherein the flush controller comprises an optical sensor for sensing accumulated sediment.

15. A method of cleaning a water filter in a water filter housing, comprising the steps of:
attaching a flush pipe to the base of the water filter housing;
attaching a flush valve to said flush pipe at a location downstream from the water filter housing;
operably connecting a controller to the flush valve; and
periodically opening the flush valve to allow a flushing flow from the water filter housing.

16. The method of claim 15, wherein the controller comprises a timer.

17. The method of claim 16, further comprising the step of setting the timer to actuate the flush valve at set intervals.

18. The method of claim 15, wherein the controller comprises a flow meter.

19. The method of claim 18, further comprising the step of setting the flow meter to actuate the flush valve after a predetermined amount of water has passed through the filter.

20. The method of claim 15, wherein the controller comprises a paddle wheel or impeller style meter.

21. The method of claim 20, further comprising the step of setting the paddle or impeller style meter to actuate the flush valve after a predetermined amount of water has passed through the filter.

22. The method of claim 15, wherein the controller comprises:
a first pressure sensor attached to a filter head inlet;
a second pressure sensor attached to a filter head outlet; and
interface logic operably attached to said first and said second pressure sensors to determine a pressure drop.

23. The method of claim 22, further comprising the step of setting the interface logic to actuate the flush valve when the pressure drop reaches a predetermined level.

24. The method of claim 15, wherein the controller comprises an optical sensor attached to the water filter housing.

25. The method of claim 24, further comprising the step of setting the optical sensor to actuate the flush valve when sediment in the water filter housing has reached a predetermined level.

26. A self cleaning water filter comprising:
a filter housing with an inlet for receiving water to be filtered and an outlet;
a water filter within the filter housing for removing particulate matter from water before it flows to the outlet, said removed matter accumulating in a bowl of said filter housing; and
a flush unit attached to said filter housing, said flush unit comprising a valve for releasing at least a portion of the contents of the filter bowl and a controller for automatically activating the flush unit.

27. The filter of claim 26 further comprising a water hammer arrestor operably connected to said flush unit.

28. The filter of claim 26 wherein the controller activates the valve to be open for a predetermined time interval.

29. The filter of claim 27 wherein the controller activates the valve to be open for one or more consecutive predetermined time intervals.

30. The filter of claim 26 wherein the controller activates the valve after a predetermined interval of time.

31. The filter of claim 26 wherein the controller activates the valve at a predetermined time of day.

32. The filter of claim 26 wherein the controller activates the valve after a predetermined amount of water has flowed through the filter housing.

33. The filter of claim 26 wherein the valve is a solenoid valve mounted in a flush pipe that is attached to the filter bowl and the controller is an interval timer connected to activate said solenoid valve for a flush cycle with a predetermined duration after the lapse of a predetermined time interval.

34. The filer of claim 26 further comprising a drain conduit located downstream from said valve and a check valve in said drain conduit to limit flow to the flushing direction.

35. A method for protecting household water-using devices from particulate matter in a water stream provided to said devices comprising:
providing a filter housing with an inlet for receiving water to be provided to said devices and an outlet;
placing a water filter within the filter housing for removing particulate matter from water before it flows to the outlet, said removed matter accumulating in said filter housing;
providing a flush unit attached to said filter housing, said flush unit comprising a flush valve for releasing at least a portion of the contents of the filter housing from the housing; and
automatically activating the flush unit when the particulate matter accumulated impairs water filter performance.

36. The method of claim 35 wherein step of activating the flush unit comprises opening the flush valve for a predetermined time interval.

37. The method of claim 35 wherein step of activating the flush unit comprises opening the flush valve for one or more consecutive predetermined time intervals.

38. The method of claim 35 wherein step of activating the flush unit comprises opening the flush valve after a predetermined interval of time.

39. The method of claim 35 wherein step of activating the flush unit comprises opening the flush valve at a predetermined time of day.

40. The method of claim 35 wherein step of activating the flush unit comprises opening the flush valve after a predetermined amount of water has flowed through the filter housing.

41. The method of claim 35 wherein step of activating the flush unit comprises opening the flush valve for a flush cycle with a predetermined duration after the lapse of a predetermined time interval.
